(19) United States
(12) Patent Application Publication
(10) Pub. No.: US 2025/0108392 A1
(43) Pub. Date: Apr. 3, 2025

(54) REUSABLE CANISTER SYSTEM FOR DISPENSING FLUID

(71) Applicant: DUNE SCIENCES, INC., Eugene, OR (US)

(72) Inventor: Richard GEIGER, Eugene, OR (US)

(21) Appl. No.: 18/832,078

(22) PCT Filed: Jan. 23, 2023
(86) PCT No.: PCT/US2023/011348

§ 371 Date: Jul. 22, 2024

Related U.S. Application Data
(60) Provisional application No. 63/302,380, filed on Jan. 24, 2022.

(51) Int. Cl. B05B 11/00; B05B 11/10

(52) U.S. Cl. CPC B05B 11/0054; B05B 11/10

(57) ABSTRACT

A reusable system and method of using the system for dispensing fluids are provided. The reusable system in accordance with the present disclosure comprises a container including a housing and an inner cavity; a replaceable cartridge configured to reside in the inner cavity of the container; a lid coupled to the container: and a puncturing element residing in an interior of the lid. The puncturing element is configured to open the cartridge upon closure of the lid by puncturing a top of the cartridge.

### CROSS-REFERENCE TO RELATED APPLICATIONS

This application claims priority to U.S. Provisional Patent Application US63/302,380, filed Jan. 24, 2022, the entire contents of which are herein incorporated by reference.

### TECHNICAL FIELD

The present disclosure relates generally to a dispenser for dispensing flowable materials, and more specifically to a reusable canister system for dispensing an amount of its fluid content.

### BACKGROUND

Most cleaning products and similar fluids are contained in disposable, single use packages. This results in a large amount of waste as a byproduct. Some cleaning products are commercially available in bulk quantities in portable storage containers such as bottles, jars, and canisters. The cleaning products may comprise viscous liquid substances or fluid gels, for example. In these instances, consumers may transfer a certain amount of the cleaning product from the storage container to a receiving container for the purposes of daily use. Facilitating the transfer of the cleaning product from the storage container where it is stored in bulk quantity to the receiving container typically necessitates the use of additional tools, such as a closure for sealing the storage container, a dispensing aid for the receiving container, and a funnel where the opening of the receiving container is particularly narrow or small compared to the opening of the storage container. The need for so many separate items may make the whole process resource intensive, difficult, and time consuming. Additionally, the need for the separate items and transferal process may increase the number of steps, risk of error, and risk of spillage. Furthermore, such a process may be problematic in situations where ease, consistency, and speed of delivery are important, while at the same time reducing waste.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings.

FIG. 1A shows a perspective view of an embodiment of a reusable canister system, according to the present disclosure;

FIG. 1B shows a perspective view of an alternative embodiment of the reusable canister system, according to the present disclosure;

FIG. 2A shows a perspective view of the reusable canister system of FIG. 1A with an attached sprayer in accordance with the present disclosure;

FIG. 2B shows a perspective view of the reusable canister system of FIG. 1A with an attached pump in accordance with the present disclosure;

FIG. 2C shows a perspective view of the reusable canister system of FIG. 1A with an attached cap assembly in accordance with the present disclosure;

FIG. 3A shows a perspective view of a sealed cartridge to be used in the reusable canister system in accordance with the present disclosure;

FIG. 3B shows a top view of the sealed cartridge of FIG. 3A in accordance with the present disclosure;

FIG. 3C shows an alternative embodiment of a cartridge top illustrating various elements in accordance with the present disclosure;

FIG. 3D shows an alternative embodiment of a cartridge top illustrating various elements in accordance with the present disclosure;

FIGS. 4A and 4B illustrate perspective views of the reusable canister system showing an interior of a lid of the system in accordance with the present disclosure;

FIGS. 4C and 4D illustrate perspective views of an alternative embodiment of the reusable canister system showing various elements of the interior of a lid of the system in accordance with the present disclosure;

FIG. 5A shows a perspective view of an opened cartridge removed from the reusable canister system in accordance with the present disclosure;

FIG. 5B shows a top view of the opened cartridge of FIG. 5A in accordance with the present disclosure; and

FIG. 6 illustrates a flow chart of an example technique for using the reusable canister system to dispense a flowable material in accordance with the present disclosure.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order-dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical contact with each other. “Coupled” may mean that two or more elements are in direct physical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A) B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

Embodiments herein relate to reusable systems, articles of manufacture, and techniques of using the systems or articles of manufacture for dispensing flowable materials. The reusable system may include a container including a housing and an inner cavity; a replaceable cartridge configured to reside in the inner cavity of the container (when in use); a lid coupled to the container; and a puncturing element residing in an interior of the lid. In embodiments, the puncturing element of the reusable system is configured to open the cartridge by perforating a top of the cartridge upon closure of the lid. In one example, the reusable system of the present disclosure may provide a quick and convenient way of dispensing liquids from sealed cartridges, while reducing waste.

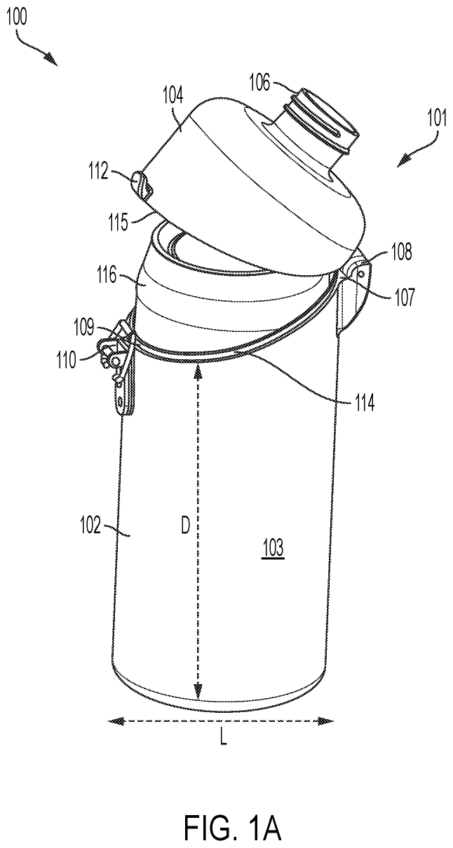

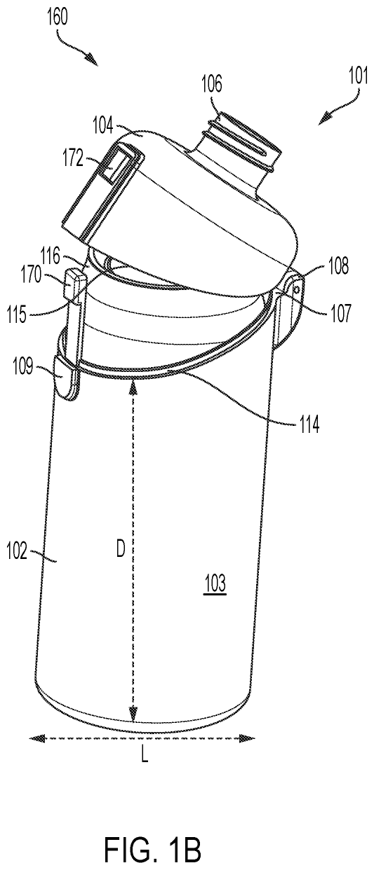

FIG. 1A depicts a perspective view 100 of an embodiment of a reusable canister system 101, according to the present disclosure. FIG. 1B depicts a perspective view 160 of an alternative embodiment of the reusable canister system 101, according to the present disclosure. FIGS. 1A and 1B will be described herein collectively.

The reusable canister system 101 in accordance with the present disclosure may comprise a container 102, a lid 104, and a puncturing element (not shown in FIGS. 1A-1B) residing in an interior of the lid 104. The container 102 of the reusable canister system 101 may further comprise a housing 103 and an inner cavity. The housing 103 may include an open upper end and a closed lower end. As shown, the inner cavity enclosed by the housing 103 of the container 102 is configured to accommodate a cartridge 116 containing a flowable material. In some examples, the cartridge 116 may be replaceable such that once the flowable material has exited cartridge 116 (a situation in which the cartridge 116 may be referred to as “spent”), then the spent cartridge 116 may be removed from the housing 103 and a new cartridge 106 (e.g., a cartridge with flowable material) may be positioned therein.

In the illustrated example of FIGS. 1A-1B, the open upper end of the housing 103 of the container 102 includes a sloped edge 114, which may provide easier access to the cartridge 116 and enables quick insertion or removal of the cartridge 116 from the reusable canister system 101. In other examples, however, this accessibility function may be provided by the presence of two or more grooves on the edge of the open upper end of the housing 103, instead of edge 114, and/or some additional or alternative physical configuration which may facilitate access to the cartridge 116 by a user of the reusable canister system 101.

The lid 104 may be attached to the open upper end of the housing 103. As shown, the lid 104 may include a dispensing spout 106 for dispensing fluids or flowable materials from the cartridge 116. The words “fluid” and “flowable material” may interchangeably be used throughout the disclosure and may refer, for example, to a gel, a liquid, a viscous liquid, and/or some other type of material as described in greater detail below. A size of the dispensing spout 106 may vary with different examples. In the illustrated example, the dispensing spout 106 is circular in shape. In other examples, however, the dispensing spout 106 may have other shapes including but not limited to square, oval, rectangular, hexagonal, triangular, and so on. In the illustrated example, the lid 104 includes a sloped edge 115, which is configured to fit the sloped edge 114 of the housing 103 of the container 102. In other examples, however, the edge of the lid 104 may be shaped in a number of other ways based on the shape of the open upper end of the housing 103 of the container 102. For example, if the edge 114 of the open upper end of the housing 103 comprises grooves (not shown), the edge 115 of the lid 104 may comprise corresponding protrusions configured to fit into the grooves of the edge 114 of the housing 103.

In some examples, a part of the lid 104 may be coupled or permanently bonded to the open upper end of the housing 103 of the container 102 by thermal or ultrasonic welding, adhesives, or any other suitable means. In the illustrated example, a part of the lid 104 is shown to be hingeably attached to a first portion 107 of the edge 114 of the upper end of the housing 103 via a hinge member 108. The hinge member 108 may allow the lid 104 to swing open or close the upper end of the housing 103 of the container 102 without being detached from the system. In the embodiments of the reusable canister system 101 depicted in FIGS. 1A and 1B, the lid 104 is depicted as being hinged to the housing 103, but in an open configuration to reveal the replaceable cartridge 116.

The lid 104 of the reusable canister system 101 may be closed and held together with the upper end of the housing 103 via a mechanical fastener located on a second portion 109 of the edge 114 of the upper end of the housing 103. As shown, the second portion 109 may be configured to be located opposite to the first portion 107 of the edge 114 of the upper end of the housing 103, although it will be recognized that other embodiments may additionally or alternatively locate the second portion 109 at some other location of the edge 114 (or edge 115) with respect to first portion 107. In some cases, the mechanical fastener may be a latch as depicted in FIG. 1A, wherein a clamp 110 located on the second portion 109 of the upper end of the housing 103 is configured to engage a hook 112 on the lid 104. This allows the lid 104 to be releasably engaged or latched to the housing 103 of the container 102. In other cases, the mechanical fastener may be a slot and tab fastener as depicted in FIG. 1B, wherein a built-in tab 170 located on the second portion 109 of the upper end of the housing 103 is configured to engage a built-in slot 172 in an interior of the lid 104. This also allows the lid 104 to be releasably engaged with the housing 103 of the container 102. The slot 172 and tab 170 of the fastener are configured to fit with one another and may include a wide variety of shapes. While the present disclosure illustrates two types of fasteners, other alternative embodiments may include various other types of fasteners, without departing from the scope of this disclosure.

While not shown, in some examples, the lid 104 may be a snap-on lid instead of a hinged one. In such examples, the snap-on lid may have a dispensing spout (such as the dispensing spout 106 of the lid 104) and a gasket to fill voids that may exist in the container-lid interface. To close the container of the reusable canister system, the snap-on lid slides down and snaps in place in such examples. While not shown, in yet other examples, the lid 104 may be a screw-on lid. The screw-on lid may have a dispensing spout (such as the dispensing spout 106 of the lid 104) and internal threads configured to fit with external threads on the open upper end of the container. To close the container of the reusable canister system, the screw-on lid may slide down and thread together with the upper end of the container in such examples.

The reusable canister system 101 of the present disclosure may be made of suitable materials including but not limited to metal (e.g., aluminum, stainless steel), plastic (e.g., polyethylene and polypropylene), glass, or cardboard. In some examples, the reusable canister system 101, or one or more portions thereof, may be configured to be opaque, while in other examples, the reusable canister system 101, or one or more portions thereof, may be configured to be transparent or translucent. Thus, the reusable canister system 101, according to the present disclosure, is typically composed of a safe, non-toxic, lightweight, and sturdy material.

The reusable canister system 101 in accordance with the present disclosure may be of any suitable shape and construction. The most convenient shape from the viewpoint of the manufacture is cylindrical; however, any other desired shape is also within the scope of the invention. In the illustrated example, the reusable canister system 101 has a shape of a cylinder. In other examples, however, the reusable canister system 101, or one or more portions thereof, may have a cross-sectional shape of a rectangle, oval, square, circle, triangle, etc. As shown, the inner cavity enclosed by the housing 103 of the reusable canister system 101 may have a depth D and a diameter L. The reusable canister system 101 of the present disclosure may be of various sizes. Accordingly, the depth D and the diameter L of the reusable canister system 101 may vary with variously sized canisters. As such, a size of the cartridge 116 retained within the inner cavity of the reusable canister system 101 may also vary with variously sized canister systems, without departing from the scope of this disclosure.

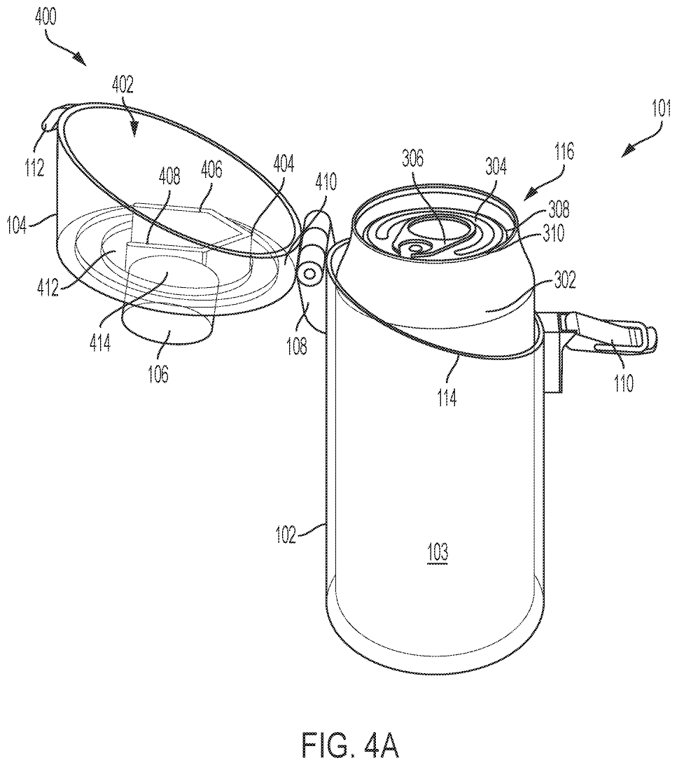

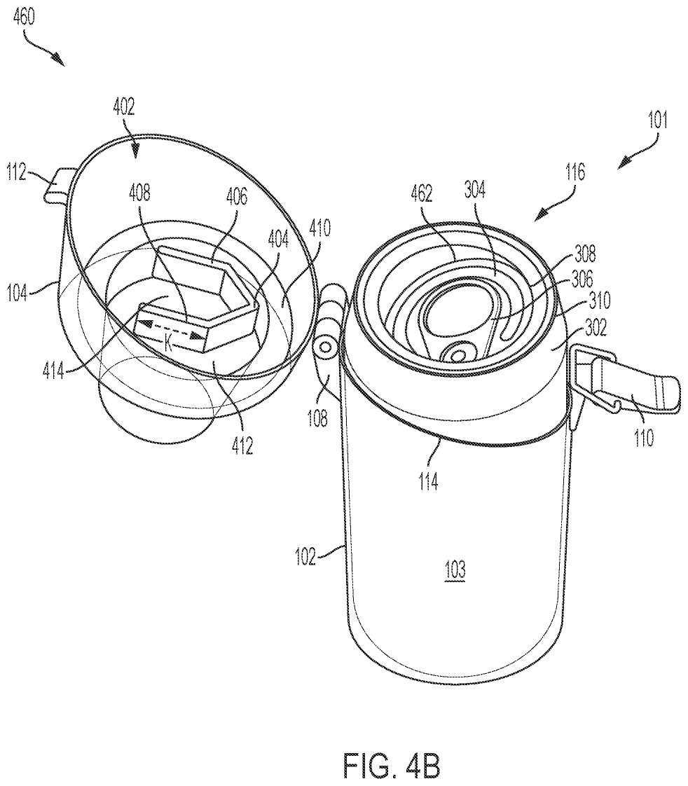

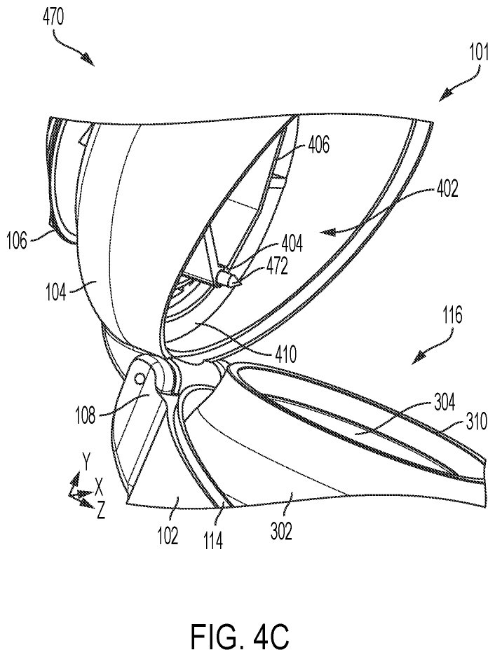

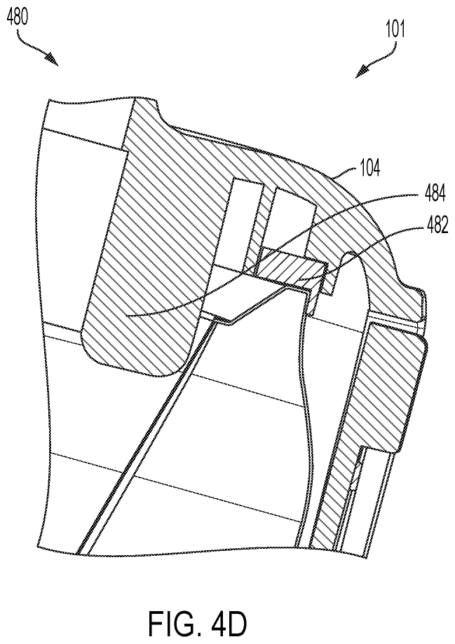

The reusable canister system 101, according to the embodiments of the present invention, may comprise a puncturing element (not shown in FIGS. 1A and 1B) residing in an interior of the lid 104. The puncturing element in accordance with the embodiments of the present disclosure is configured to perforate and open the cartridge 116 retained within the inner cavity of the reusable canister system 101. More details regarding the puncturing element of the reusable canister system 101, and its functional aspects, are presented in FIGS. 4A and 4B.

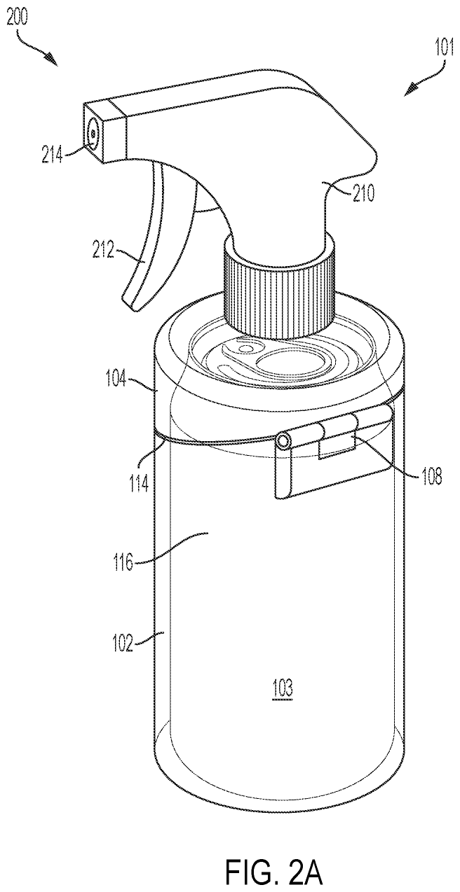

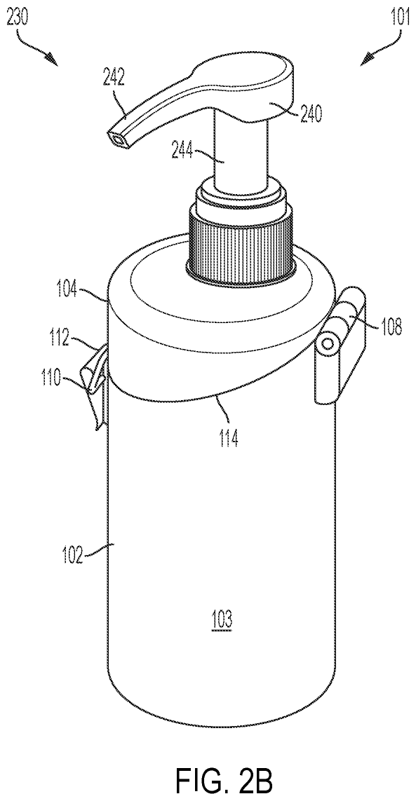

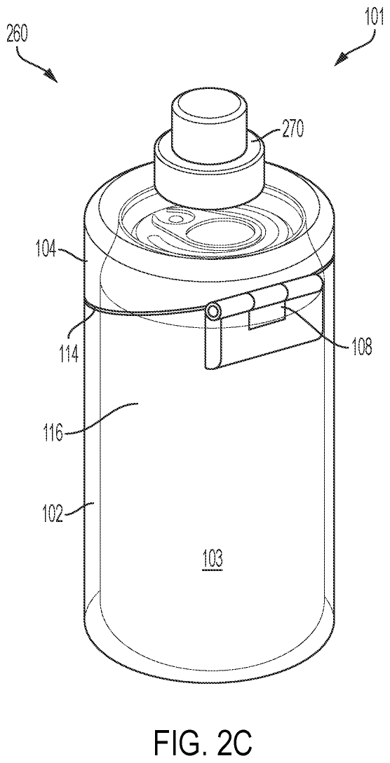

FIGS. 2A-2C depict three example embodiments of the reusable canister system 101 of FIG. 1A, showing the system 101 in example usable forms for dispensing fluids. As such, the components previously introduced are numbered similarly in these figures and are not re-introduced for brevity. FIGS. 2A-2C will be described herein collectively.

The reusable canister system 101 depicted in a first example embodiment 200 in FIG. 2A shows the system is loaded with the cartridge 116 and the lid 104 of the system is in a closed position. In the illustrated example, a sprayer 210 is shown to be attached or screwed on to the dispensing spout 106 of the lid 104. The sprayer 210 may comprise a trigger 212 and a nozzle assembly 214. A sprayer connector (not shown), integrally formed with or otherwise coupled to the sprayer 210, establishes a fluid communication between the sprayer 210 and a flowable material in the cartridge 116, thereby allowing the flowable material to be dispensed in a stream pattern, spray pattern, some other type of pattern, or as a foam through the nozzle assembly 214.

The reusable canister system 101 depicted in a second example embodiment 230 in FIG. 2B shows the system is loaded with the cartridge 116 and the lid 104 of the system is in a closed position. In the illustrated example, a pump 240 is shown to be attached or screwed on to the dispensing spout 106 of the lid 104. The pump 240 may comprise a dispenser head 242, a piston 244, and a plunger tube (not shown). The plunger tube of the pump 240 may be disposed in the flowable material of the cartridge 116, thereby establishing a fluid communication between the pump 240 and the flowable material of the cartridge. An actuation of the pump 240 may allow pumping a quantity of the flowable material to be dispensed via the dispenser head 242.

The reusable canister system 101 depicted in a third example embodiment 260 in FIG. 2C shows the system is loaded with the cartridge 116 and the lid 104 of the system is in a closed position. In the illustrated example, a cap assembly 270 is shown to be attached or screwed on or molded in to the dispensing spout 106 of the lid 104. The removal of a closure cap of the cap assembly 270 may allow the flowable material of the cartridge 116 to be poured out of the dispensing spout 106 of the reusable canister system 101.

It is to be understood that these variations of the reusable canister system disclosed herein for dispensing fluids or flowable materials may be included within the scope of this disclosure. In yet other examples, the dispensing spout 106 of the reusable canister system may be attached or connected to various other types of dispensing devices without departing from the scope of this disclosure.

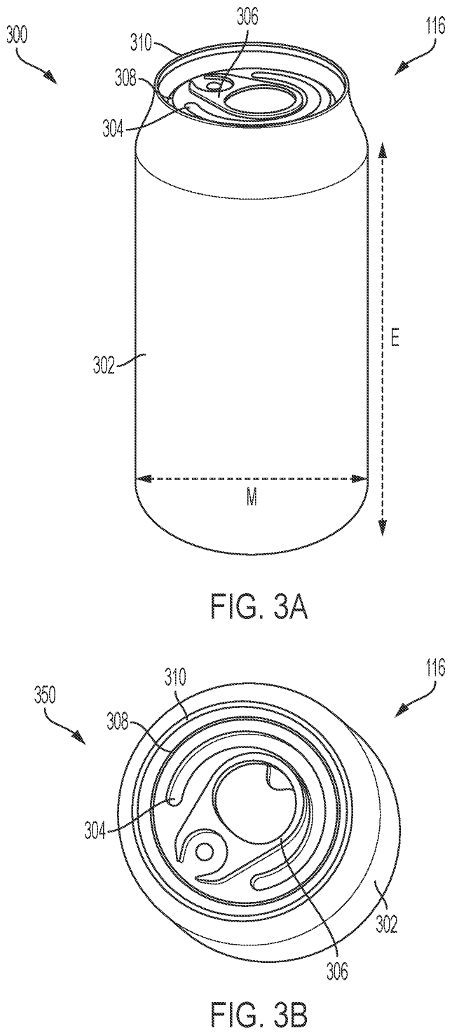

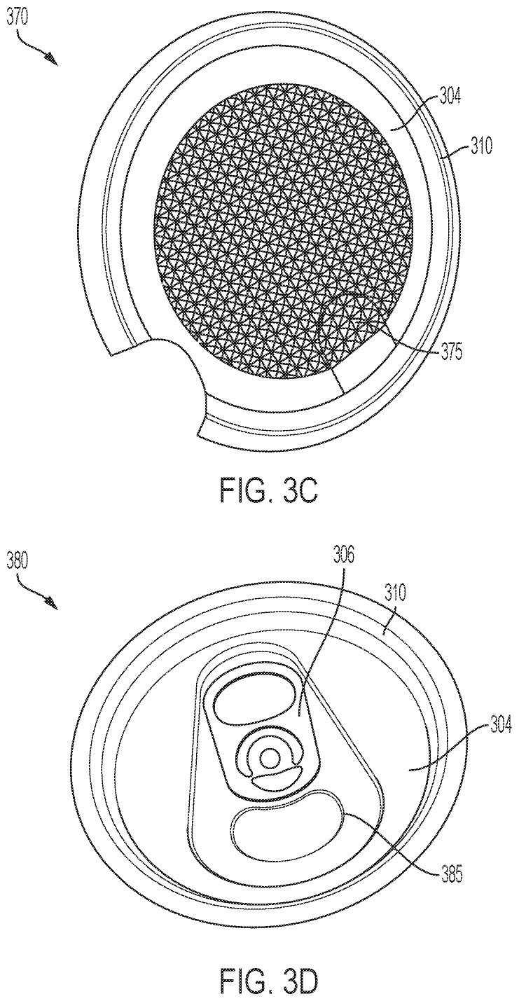

FIGS. 3A and 3B depict a perspective view 300 and a top view 350 of the cartridge 116 being used in the reusable canister system 101, respectively, according to the present disclosure. As such, the components previously introduced are numbered similarly in these figures and are not re-introduced for brevity. FIGS. 3A and 3B will be described herein collectively. As depicted in FIGS. 3A and 3B, the cartridge 116 is sealed and is ready to be loaded into the reusable canister system 101 of the present disclosure.

As depicted, the cartridge 116 may comprise a top 304 and a body 302. In the illustrated example, the body 302 of the cartridge 116 is cylindrical in shape with a flat base. The body 302 of the cartridge 116 may have a depth E and a diameter M. The cylindrical body 302 of the cartridge 116 is shaped or configured to fit into the cylindrical inner cavity enclosed by the housing of the reusable canister system 101, according to the present disclosure. As such, the depth E and the diameter M of the body 302 of the cartridge 116 is configured to be smaller than the depth D and the diameter L of the reusable canister system 101, respectively. In other examples, however, the cartridge 116 may be configured to have other cross-sectional shapes (e.g., rectangle, oval, square, circle, triangle, etc.) with varying sizes depending on the shape and size of the reusable canister system 101. The body 302 of the cartridge 116 may be made of suitable materials including but not limited to metals (e.g., aluminum can), ceramic, recyclable plastic, waxed or glossy cardboard, or other biodegradable alternatives.

Thus, in certain embodiments, the cartridge is designed to be recyclable, such as constructed from aluminum, and may use unique form factors or may use a form factor similar to known containers such as a common drink can. In other embodiments, the cartridge itself is designed to be reusable, such as refillable.

The top 304 of the cartridge 116 may be a flat circular structure, as shown in the illustrated example in FIGS. 3A-3B. The top 304 of the cartridge 116 may be sealed and attached to the body 302 of the cartridge 116, such that the cartridge 116 is airtight. In some examples, the top 304 of the cartridge 116 may have shapes other than a circle, such as a rectangle, oval, square, triangle, and so on based on the shape of the body 302 of the cartridge 116. The top 304 of the cartridge 116 is the region that is configured to interact with, and generally be adjacent to an interior of the lid 104 of the reusable canister system 101 when the lid 104 is in the “closed” position. The top 304 of the cartridge 116 may optionally have a rim 310. As shown in FIGS. 3A-3B, the rim 310 may be an elevated portion encircling the top 304 of the cartridge 116. The rim 310 may function in positioning the top 304 of the cartridge 116 with respect to the lid 104 of the reusable canister system 101. In other examples, however, the rim 310 may or may not be present on the top 304 of the cartridge 116.

As depicted, the top 304 of the cartridge 116 may have a scored region 308. The scored region 308 is provided to define a selectively weakened, fracturable, or puncturable zone on the top 304 of the cartridge 116. The scored region 308 may have at least one score line positioned on the top 304 of the cartridge 116, such as the circular score line shown in the illustrated example. In some examples, there may be more than one score line positioned on the top 304 of the cartridge 116. While the illustrated example shows a circular score line, other examples may show various other shapes of the score line including but not limited to rectangular, oval, triangular, square, hexagonal, and so on. The scored region 308 of the top 304 of the cartridge 116 is configured to shear when a predetermined force is applied thereto.

The top 304 of the cartridge 116 may optionally have a pull-tab 306, as shown in the illustrated example. In some examples, however, the pull-tab 306 may be completely omitted from the top 304 of the cartridge 116. The top 304 of the cartridge 116 may be made of suitable materials including but not limited to metals (e.g., aluminum alloy, stainless steel), plastic, recyclable plastic, cardboard, membrane, paper-based material, etc.

The interior of the cartridge 116, according to the present disclosure, is configured to hold fluids or flowable materials. The examples of flowable materials to be used in the cartridge 116 may span a wide variety of cleaning products, chemicals, consumables, or many other viscous/non-viscous liquid substances. Among cleaning products and chemicals, the examples may include without limitation, liquid laundry detergents, dishwashing liquids, bleach, liquid soap or cleaners, hand sanitizers, acids or alkalines, acetone, vinegar, alcohol-based solutions, perfumes, air-fresheners, etc. Among consumables, the examples may include without limitation, water, carbonated or non-carbonated beverages, juices, sparkling drinks, energy drinks, tea, coffee, milkshakes, sodas, baby formula, syrups, honey, oil, or other fluid/gel food products, dietary supplements, or medicines. In yet other examples, the flowable materials to be used in the cartridge 116 may include particulate, powdery, and/or granular substances without departing from the scope of this disclosure.

FIG. 3C depicts a perspective view 370 of an alternative embodiment of a cartridge top illustrating various elements in accordance with the present disclosure. The perspective view 370 of the cartridge top may not include a scored region. In certain embodiments, the cartridge (e.g., cartridge 116) may be configured to have a top that completely lacks the scored region. As depicted in the example of FIG. 3C, the top 304 may be a flat and thin structure without a score line. The top 304 may include the rim 310, as described previously with reference to FIGS. 3A-3B. In some examples, the top 304 may optionally include a peel off portion 375, as shown in FIG. 3C. The peel off portion 375 may be a flap-like structure attached to a base of the rim 310. In some examples, the top 304 of the cartridge may include more than one peel off portion 375. In other examples, however, the peel off portion 375 may be completely omitted from the top 304 of the cartridge. It is to be understood that these variations of the cartridge top disclosed herein are included within the scope of this disclosure. Additionally, it is to be understood that cartridges with a non-scored top may be utilized with the reusable canister system 101 without departing from the scope of this disclosure.

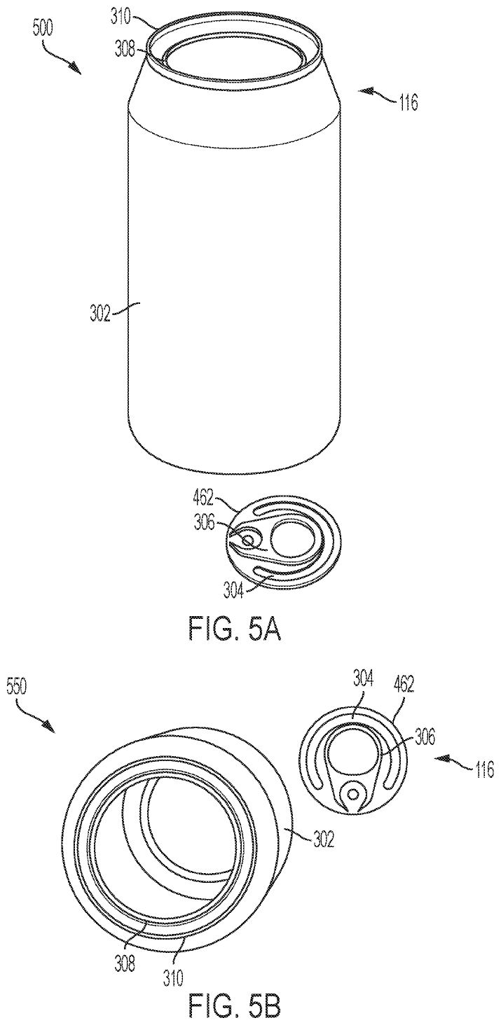

FIG. 3D depicts a perspective view 380 of another alternative embodiment of a cartridge top illustrating various elements in accordance with the present disclosure. The cartridge top 304, in the illustrated example, may appear to be similar to a top of a soda can. As depicted in the perspective view 380, the top 304 may include the rim 310 and the pull-tab 306, as described previously with reference to FIGS. 3A-3B. The cartridge top 304, in the example of FIG. 3D, may be configured to have a first region 385 which may be a defined region that allows partial opening of the cartridge without removing the entire top. The opening of the cartridge top at the first region 385 may also be facilitated by the configuration of the pull-tab 306. More details will be presented regarding the opening of such cartridge tops in FIGS. 5A-5B. It is to be understood that this variation of the cartridge top disclosed herein is also included within the scope of this disclosure.

FIG. 4A depicts a first perspective view 400 of the reusable canister system 101 showing an interior of the lid 104 of the system in accordance with the present disclosure. The first perspective view 400 of FIG. 4A shows a sealed cartridge loaded in the system. FIG. 4B depicts a second perspective view 460 of the reusable canister system 101 showing an interior of the lid 104 of the system. The second perspective view 460 of FIG. 4B shows an opened cartridge present in the system. As such, the components previously introduced are numbered similarly in these figures and are not re-introduced for brevity. FIGS. 4A and 4B will be described herein collectively.

As shown, the interior of the lid 104 of the reusable canister system 101 comprises a puncturing element 402. The puncturing element 402 may further comprise a piercer 404, a first extension 406, and a second extension 408. In the illustrated example, the piercer 404 is a V-shaped structure with a single point as shown in FIGS. 4A-4B. The piercer 404 of the puncturing element 402 is positioned in the interior of the lid 104 such that the single point of the piercer 404 comes in contact with the scored region 308 of the top 304 of the cartridge 116, upon closure of the lid 104. The first extension 406 and the second extension 408 of the puncturing element 402 serve as the extensions of the piercer 404 and are configured to be parallel to each other, in the illustrated example. Each of the first extension 406 and the second extension 408 may have a length K. As depicted, the first extension 406 and the second extension 408 of the puncturing element 402 are positioned in the interior of the lid 104 such that they come in contact with the top 304 of the cartridge 116 at regions other than the scored region 308, upon closure of the lid 104.

The puncturing element 402, according to the present disclosure, is configured to open the cartridge 116 by perforating either a portion of or an entirety of the top 304 of the cartridge 116 along the scored region 308, as the lid 104 of the reusable canister system 101 is closed. FIG. 4A shows a view of the system before closing the lid 104 or before the cartridge 116 is punctured, while FIG. 4B shows a view of the system after the cartridge 116 is punctured or after the puncturing element 402 of the system has completed its functions. Upon closure of the lid 104, the piercer 404 of the puncturing element 402 first hits on or just inside the scored region 308 and functions to provide a localized pressure on the top 304 of the cartridge 116 to pierce or puncture it along the score line. Subsequently, the first extension 406 and the second extension 408 of the puncturing element 402 function as a punch to push the punctured top 304 of the cartridge 116 downwards and away from the region that was first pierced, such that the top 304 separates (partially or fully) from the cartridge 116 along the score line of the scored region 308. For example, FIG. 4B shows an approximately two-thirds portion of the top 304 of the cartridge 116 is separated from the cartridge 116 along the scored region 308 and is angled downward after the completion of the function of the puncturing element 402. The perforation or puncturing of the top 304 of the cartridge 116 by the puncturing element 402 creates an outer edge 462 of the separated top 304, as depicted in FIG. 4B. In embodiments, cartridge 116 is configured such that a section of at least two-thirds of the length of the scored region is separated to provide proper separation of the components and dispensing of the contained fluids. In certain embodiments, it may be desired to maintain a portion of the top 304 connected to the cartridge after perforation/puncturing.

While the puncturing element 402, in the illustrated example, shows a V-shaped structure of the piercer 404 with a single point and two parallel extensions (e.g., the first extension 406 and the second extension 408), the shape and structure of the puncturing element 402 may vary in alternative embodiments. For example, in some embodiments the structure of the piercer 404 of the puncturing element 402 may have two or multiple points, instead of the single point. In some embodiments, the piercer 404 may have a spear-shaped profile; while in other embodiments, the piercer 404 may be a cross-shaped pointed member. In yet other embodiments, the piercer 404 may have a curved structure without a pointed profile. In some examples, the extensions of the puncturing element 402 may be non-parallel to each other. The length K of each extension may also vary with various embodiments. Moreover, different embodiments may show a different number of extensions. Some examples may have only one extension, while other examples may show two or more extensions.

Additionally, the interior of the lid 104 of the reusable canister system 101 may comprise a central aperture 414, a platform 410 surrounding the puncturing element 402, and a space 412 between the puncturing element 402 and the platform 410. As shown, the central aperture 414 may connect with the dispensing spout 106 of the lid 104, thereby providing a passage for fluids to be dispensed. The puncturing element 402 may be configured to surround the central aperture 414, as depicted in FIGS. 4A-4B. The platform 410 may be configured to be a circular platform surrounding the puncturing element 402, in the illustrated example. In some examples, however, the shape of the platform 410 may be non-circular or may vary depending on the shapes of the reusable canister system 101 and the cartridge 116. The platform 410 may function in conjunction with the rim 310 of the cartridge 116 in positioning the top 304 of the cartridge 116 with respect to the lid 104 of the reusable canister system 101, when the system is closed. Upon closure of the lid 104, a contact between the platform 410 and the rim 310 of the cartridge 116 may assist in accurate positioning of the puncturing element 402 on the top 304 of the cartridge 116. In some embodiments, the platform 410 may be made of silicon or other gasket material that may function to seal the rim 310 of the cartridge 116, upon closure of the lid 104. This allows the fluid in the punctured cartridge to be restricted from leaking through regions other than the dispensing spout 106 of the system.

Shown in FIGS. 4C and 4D are perspective views of an alternative embodiment of the reusable canister system 101 indicating variations of the puncturing element in the interior of the lid in accordance with the present disclosure. As such, the components previously introduced are numbered similarly in these figures and are not re-introduced for brevity. FIGS. 4C and 4D will be described herein collectively.

FIG. 4C depicts a perspective view 470 of an alternative embodiment of the reusable canister system 101 showing an interior of the lid 104 of the system. In this alternative embodiment, the puncturing element 402 of the lid 104 may further comprise a pin 472. In the illustrated example, the pin 472 is integrated with or coupled to the single point of the V-shaped piercer 404 of the puncturing element 402. The pin 472 may serve as a hard pointed end of the piercer 404 that may provide the initial load at a region on the top 304 of the cartridge 116 to begin the tearing or piercing. In embodiments, the pin 472 may be made of metal, wood, plastic, glass, recyclable plastic, cardboard, etc. This variation of the puncturing element may be utilized to puncture/perforate a cartridge top lacking a scored region, e.g., as shown in FIG. 3C. In such examples, the non-scored cartridge top may be made sufficiently thin which may easily be pierced using the pin 472 of the puncturing element 402. For example, a metallic pin of the puncturing element may assist in piercing a metal-based thin cartridge top lacking a score line. In other examples, however, this variation of the puncturing element may be utilized to perforate a cartridge top that includes a scored region.

FIG. 4D depicts a perspective view 480 of an alternative embodiment of the reusable canister system 101 showing an interior of the lid 104 of the system. In this alternative embodiment, the puncturing element 402 of the lid 104 may further include a driving element 484, which may be configured to apply force and push the punctured cartridge top down into the cartridge. Thus, the driving element 484 may assist in removing the punctured cartridge top, such that a dip tube of a sprayer or a plunger tube of a pump may easily be inserted into the punctured cartridge through the dispensing spout 106 of the reusable canister system. The driving element 484 may be coupled to the extensions (e.g., the first extension 406 and/or the second extension 408) of the puncturing element 402.

The alternative embodiment, shown in FIG. 4D, may additionally include a gasket 482 coupled to the platform 410 in the interior of the lid 104 of the reusable canister system 101. The gasket 482 may be a silicon structure projecting from the platform 410. In embodiments, the gasket 482 may project from the platform 410 along a portion or an entirety of a circumference of the platform 410. The gasket 482 may function in sealing around an outside of the rim 310 of the cartridge 116, when the system is closed. This may effectively restrict any undesired leakage of fluid from the system after the cartridge is punctured. Moreover, the gasket 482 may aid in positioning or centering the cartridge 116 with respect to the lid 104, upon closure of the system. It is to be understood that all these embodiments of the reusable canister system disclosed herein are included within the scope of this disclosure.

Furthermore, the perforation of the top 304 of the cartridge 116 by the puncturing element 402, as described in FIGS. 4A-4D, may generate an audible indicator or feedback. The audible indicator or feedback confirms that the opening of the cartridge 116 is successful. The audible indicator provided by the resistance or pressure while puncturing the cartridge 116 may be analogous to the experience of opening a can of soda or beer.

As described previously with reference to FIGS. 1A-1B, the lid of the reusable canister system, according to the present disclosure, may be of different types such as a hinged lid, screw-on lid, or snap-on lid. The reusable canister system 101 in FIGS. 4A, 4B, 4C, and 4D shows a hinged lid, wherein a portion of the lid 104 is coupled to the upper end of the housing 103 via the hinge member 108. Due to the presence of the hinge member 108, closing of the lid 104 from an open position may make an angle (e.g., 180-degree angle). In case of hinged lids, the physical action of closing or shutting the lid 104 provides the force to actuate puncturing of the top 304 of the cartridge 116. As shown in the illustrated example, the piercer 404 of the puncturing element 402 is configured to be located closer to the hinged portion of the lid 104, while the extensions (e.g., the first extension 406 and the second extension 408) are configured to be located farther from the hinged portion of the lid 104. This configuration allows the piercer 404 of the puncturing element 402 to make contact with and puncture the top 304 of the cartridge 116 before the extensions push the top 304 downwards, upon closure of the lid 104.

In embodiments where the lid 104 of the reusable canister system is a snap-on lid, the lid may be configured to be detached from the housing while the system is opened. To close the system, the snap-on lid may slide down the upper end of the housing of the reusable canister system and snap in place. In case of snap-on lids, the physical action of closing or shutting the lid may provide the force to actuate puncturing of the top 304 of the cartridge 116. In such examples, the extensions of the puncturing element may have a ramped configuration such that the ramped extensions make contact with the top of the cartridge after the piercer has punctured the top, upon closure of the snap-on lid.

In embodiments where the lid 104 of the reusable canister system is a screw-on lid, the lid may be configured to be detached from the housing while the system is opened. To close the system, the screw-on lid may slide down the upper end of the housing and thread together. The screw-on lid may be rotated on the upper end of the housing to screw it tight. In case of screw-on lids, the threads provide the direction to actuate puncturing of the top 304 of the cartridge 116 in response to a user screwing-on the lid. As the screw-on lid starts to rotate on the upper end of the housing, the puncturing element may hit or make contact with the top of the cartridge at a desired time, thereby perforating the cartridge top. Additionally, in such examples, the extensions of the puncturing element may have a ramped configuration such that the ramped extensions make contact with the top of the cartridge after the piercer has punctured the top, while rotation of the screw-on lid. Full or partial separation of the top of the cartridge may occur (e.g., along the scored region), depending on the extent of the threads. In another example, a full rotation of the screw-on lid may lead to a complete separation of the cartridge top along the score line, while a partial rotation of the screw-on lid may lead to a partial separation (e.g., a two-thirds portion) of the top of the cartridge along the score line.

FIGS. 5A and 5B depict a perspective view 500 and a top view 550 of the cartridge 116 removed from the reusable canister system 101, respectively, according to the present disclosure. As such, the components previously introduced are numbered similarly in these figures and are not re-introduced for brevity. FIGS. 5A and 5B will be described herein collectively.

In FIGS. 5A and 5B, an opened cartridge 116 is shown with its top 304 entirely removed. FIGS. 5A and 5B may be appreciated as an example of the cartridge, wherein the cartridge top is perforated along the scored region 308 and is fully separated from the body 302 of the cartridge by the puncturing element 402 of the reusable canister system 101, according to the present disclosure. Additionally, the outer edge 462 of the separated top 304 of the cartridge 116 is also visible in FIGS. 5A-5B.

In some examples, the reusable canister system of the present disclosure may be utilized without using the puncturing element of the system. In such examples, the top 304 of the cartridge 116 may be opened manually (e.g., using the pull-tab 306) without puncturing by the puncturing element of the system. The manually opened cartridge may then be loaded or inserted into the reusable canister system, according to the present disclosure, for dispensing fluid out of the opened cartridge. In other examples, however, the pull-tab 306 may be completely omitted from the top 304 of the cartridge 116 to prevent the cartridge 116 from being manually opened. In such examples, the cartridge (without a pull-tab) may be opened using the puncturing element of the reusable canister system of the present disclosure.

In another embodiment, a cartridge with a top that is capable of being partially opened (e.g., as shown in FIG. 3D) may be utilized. In such embodiments, the cartridge top may or may not be punctured by the puncturing element of the lid of the reusable canister system. In one example, the cartridge top may be opened manually (e.g., using the pull-tab 306 as shown in FIG. 3D) either before or after the cartridge is inserted into the system. In such examples, the puncturing element may be completely omitted from the lid of the reusable canister system. The manually opened cartridge top (e.g., the cartridge top of FIG. 3D) may have a hole created because of the manual opening and/or the configuration of the pull-tab 306. The hole may be created at the first region 385 (e.g., as shown in FIG. 3D) of the cartridge top and the hole may (or may not) be centered. When the hole in the cartridge top is not centered, the cartridge may be aligned in the reusable canister system using an alignment feature. This alignment would allow the dispensing spout of the lid to be aligned over the hole in the cartridge such that a dip tube of a sprayer or a plunger tube of a pump may fit down into the cartridge, or the alignment may otherwise enable proper dispensing of the contents of the cartridge. Upon closure of the lid, the system may be sealed in a similar fashion as described previously in FIG. 4D. The cartridge top may be sealed against the seal in the lid providing a “wet” volume inside the cartridge as well as in the space between the top of the cartridge and the lid of the system.

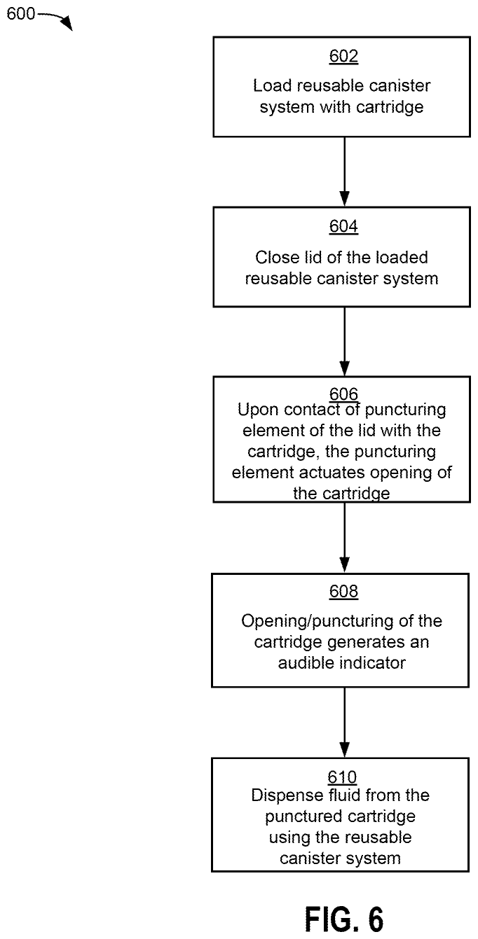

FIG. 6 provides the operations of an example method 600 for using a reusable canister system, such as the reusable canister system 101 of the present disclosure, to dispense fluids or flowable materials. The operations of method 600 may be carried out in whole or in part using the reusable canister system 101.

In operation 602, a reusable canister system (e.g., reusable canister system 101) is loaded with a sealed cartridge (e.g., cartridge 116) comprising fluid or flowable material (e.g., a liquid cleaning product, consumable, etc.). The reusable canister system includes a housing (e.g., housing 103) with an inner cavity retaining the cartridge, a lid (e.g., lid 104) coupled to the housing, and a puncturing element (e.g., puncturing element 402) residing in an interior of the lid.

Following loading, in operation 604, the lid of the loaded reusable canister system is closed to allow the puncturing element disposed in the interior of the lid to come in contact with a top (e.g., top 304) of the cartridge. The puncturing element may include a piercer (e.g., piercer 404) and at least one extension (e.g., first extension 406 and second extension 408) extending from the piercer, as described previously with reference to FIGS. 4A and 4B.

In operation 606, upon contact of the puncturing element of the lid with the top of the cartridge, the puncturing element actuates opening of the cartridge. The operation may include perforation of the top of the cartridge along a scored region (e.g., scored region 308) by the puncturing element. As described previously with reference to FIGS. 4A and 4B, the piercer may puncture the top of the cartridge at or near the score line and the extensions of the piercer may push the top of the cartridge downward leading to a partial or complete separation of the top from a body (e.g., body 302) of the cartridge.

In operation 608, an audible indicator or feedback upon puncturing of the cartridge is generated; indicating that opening of the cartridge is initiated/completed.

Following cartridge opening, in operation 610, fluid from the punctured or opened cartridge may be dispensed using a sprayer (e.g., sprayer 210), pump (e.g., pump 240), or various other devices attachable to a dispensing spout (e.g., dispensing spout 106) of the reusable canister system, as described previously with reference to FIGS. 2A-2C. The puncturing of the cartridge by the puncturing element of the reusable canister system establishes a fluid communication between the flowable material of the cartridge and the dispensing spout of the canister system, thereby allowing easy dispensing of the flowable material through the system.

Hence, according to the example method 600, the reusable canister system of the present disclosure is configured to puncture/perforate a fluid-filled cartridge as well as dispense the fluid from the punctured cartridge, thereby performing a dual function.

The reusable canister system of the present disclosure is a multi-use dispensing system. It is to be understood that the canister system disclosed herein may be used for dispensing any fluid-based products including but not limited to consumables, chemicals, fluid gels, etc.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

The following claims particularly point out certain combinations and sub-combinations regarded as novel and nonobvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system for dispensing a flowable material, comprising:
a container including an outer housing and an inner cavity, wherein the inner cavity of the container is configured to accommodate a cartridge which is configured to hold a flowable material;
a lid couplable to an open end of the container; and
a puncturing element residing in an interior of the lid.

2. The system of claim 1, wherein the puncturing element is configured to puncture the cartridge upon closure of the lid on the container.

3. (canceled)

4. The system of claim 1, wherein the lid is hinged to a first portion of the open end of the container via a hinge member.

5. The system of claim 4, wherein the lid is coupled to a second portion of the open end of the container via a fastener, and wherein the second portion is configured to be located opposite to the first portion of an edge of the open end of the container.

6. (canceled)

7. The system of claim 1, wherein the puncturing element is configured to perforate and separate a portion of a top of the cartridge from a remainder of the cartridge.

8. The system of claim 7, wherein the puncturing element is configured to perforate the top of the cartridge along a scored region.

9. The system of claim 8, wherein the perforation of the top of the cartridge generates an audible indicator when punctured.

10. The system of claim 1, wherein the puncturing element further comprises a piercer and at least one extension extending from the piercer.

11. (canceled)

12. The system of claim 1, wherein the lid further comprises a dispensing spout.

13. The system of claim 12, wherein the dispensing spout is coupled to a pump, sprayer, or cap.

14-18. (canceled)

19. The system of claim 1, wherein the interior of the lid further comprises a gasket coupled to a platform surrounding the puncturing element.

20. (canceled)

21. A reusable system for dispensing a flowable material, comprising:
a container including a housing and an inner cavity;
a cartridge residing in the inner cavity of the container, the cartridge including the flowable material;
a lid coupled to the container and contacting a top of the cartridge, the lid including a dispensing spout; and
a puncturing element residing in an interior of the lid;
wherein the puncturing element is configured to perforate and separate a portion of the top of the cartridge and enable a fluidic communication between the cartridge and the dispensing spout.

22. (canceled)

23. The reusable system of claim 21, wherein the puncturing element further comprises a piercer and at least one extension extending from the piercer.

24. The reusable system of claim 21, wherein the puncturing element is configured to perforate the top of the cartridge along a scored region.

25. The reusable system of claim 24, wherein the puncturing element is configured to separate at least two-thirds of the portion of the top of the cartridge along the scored region.

26. A method of using a refillable canister for dispensing a flowable material, the method comprising:
loading the refillable canister with a cartridge comprising the flowable material, the refillable canister including a housing with an inner cavity retaining the cartridge, a lid coupled to the housing, and a puncturing element residing in an interior of the lid;
closing the lid of the loaded refillable canister to allow the puncturing element to come in contact with the cartridge;
actuating an opening of the cartridge, upon contact of the puncturing element with the cartridge; and
dispensing the flowable material from the opened cartridge via a dispensing spout of the lid of the refillable canister.

27. The method of claim 26, wherein actuation of the opening of the cartridge includes perforation of a top of the cartridge along a scored region by the puncturing element upon closure of the lid.

28. The method of claim 27, wherein the puncturing element comprises a piercer and at least one extension extending from the piercer, and wherein the piercer perforates the top of the cartridge and the at least one extension pushes the top of the cartridge downward away from the perforated region.

29. The method of claim 28, wherein a two-thirds portion of the top of the cartridge is separated from a body of the cartridge along the scored region.

30. The method of claim 26, further comprising an audible indicator or feedback upon opening of the cartridge.
